(19) United States
(12) Patent Application Publication
(10) Pub. No.: US 2014/0050882 A1
(43) Pub. Date: Feb. 20, 2014

(54) SCREEN PROTECTION DEVICE FOR HAND-HELD ELECTRONIC APPARATUS

(71) Applicant: YU STAR INTERNATIONAL LIMITED, Road Town (VG)

(72) Inventor: Chang-Feng TSAI, Kaohsiung City (TW)

(73) Assignee: Yu Star International Limited, Road Town (VG)

(21) Appl. No.: 13/633,602

(22) Filed: Oct. 2, 2012

(30) Foreign Application Priority Data
Aug. 20, 2012 (TW) 101216000

(51) Int. Cl. B32B 3/10

(52) U.S. Cl. 428/131

(57) ABSTRACT

A screen protection device includes: a tempered glass sheet comprising a first surface and a second surface; a non-transparent layer positioned on the first surface and defining a transparent area for the screen protection device; and a sticking layer positioned on at least a portion of the non-transparent layer and surrounding the transparent area. An air layer is formed between a display screen of a hand-held electronic device and the transparent area, and one or more bidirectional air tunnels are formed between the sticking layer and the upper surface. When the transparent area is pressed to approach to or to contact with the display screen, air flows from the air layer to an outside space via the one or more air tunnels. Afterward, air flows from the outside space to the air layer via the one or more air tunnels when the transparent area is not pressed.

### CROSS-REFERENCE TO RELATED APPLICATIONS

This application claims the benefit of priority to Taiwanese Patent Application No. 101216000, filed on Aug. 20, 2012; the entirety of which is incorporated herein by reference for all purposes.

### BACKGROUND

The present disclosure generally relates to a screen protection device and, more particularly, to a screen protection device for a hand-held electronic apparatus that can avoid the phenomenon of Newton's rings.

To prevent a touch screen of a hand-held electronic apparatus from being scratched or smudged, many people choose to paste a screen protection sheet on a surface of the touch screen to protect the touch screen.

However, many users are not familiar with the correct attaching method of the screen protection sheet and thus cause undesirable air bubbles to occur between the screen protection sheet and the surface of the touch screen when the screen protection sheet is attached to the screen.

U.S. Pat. No. 8,004,942 discloses a kind of screen protector to avoid the air bubbles between the screen protector and the surface of the touch screen. The screen protector disclosed in the U.S. Pat. No. 8,004,942 Patent includes a plastic film having an outer perimeter and a transparent window; and a spacer provided along the outer perimeter of the plastic film surrounding the transparent window and having a thickness sufficient to space the plastic film near but not in contact with the touch screen portion; and an exposed adhesive for mounting the screen protector upon an outer perimeter of the touch screen to form an enclosed air space between the transparent window, the spacer, and the touch screen.

However, when the user presses the transparent window of the afore-mentioned screen protector, the volume of the enclosed air space between the touch screen and the screen protector shrinks and therefore the air pressure of the enclosed air space increases. As a result, part of the air in the enclosed air space is forced to flow from a side of the screen protector to the outside space. Ideally, when the user stops pressing the transparent window, the shape of the plastic film should restore to the original status before pressing, namely, the flat status. However, the elastic restoring force of general plastic film is not sufficient to suck the air to the inside of the enclosed air space from the outside space. Therefore, after multiple times of pressing the transparent window, the transparent window of the afore-mentioned screen protector deforms and becomes sunken because the amount of air in the enclosed air space reduces.

When the screen protector becomes sunken, the transparent window is equivalent to a concave lens in terms of optical effect. When the light passes through the transparent window and the touch screen, the reflected light of the transparent window and the reflected light of the touch screen form interference fringes. In this situation, multiple circular fringes arranged concentrically on the touch screen will be perceived by the user. This phenomenon is also known as Newton's rings. The presence of the Newton's rings would interfere with the images displayed by the touch screen and degrade the visual effect of the images and may even cause discomfort to human eyes.

### SUMMARY

In view of the foregoing, it can be appreciated that a substantial need exists for apparatuses that can avoid the bubbles to present between the screen protection device and the hand-held electronic device while avoiding the screen protection device from the Newton's rings.

An example embodiment of a screen protection device for a hand-held electronic device is disclosed comprising: a tempered glass sheet comprising a first surface and a second surface; a non-transparent layer positioned on the first surface of the tempered glass sheet and defining a transparent area for the screen protection device, wherein the transparent area has a shape corresponding to a display screen of the hand-held electronic device; and a sticking layer positioned on at least a portion of the non-transparent layer and surrounding the transparent area, when the sticking layer attached to a upper surface of the hand-held electronic device, an air layer is formed between the display screen and the transparent area of the screen protection device, and one or more bidirectional air tunnels are formed between the sticking layer and the upper surface of the hand-held electronic device; wherein when the transparent area of the screen protection device is pressed to approach to or to contact with the display screen, air flows from the air layer to an outside space via the one or more air tunnels, and afterward air flows from the outside space to the air layer via the one or more air tunnels when the transparent area is not pressed.

Another example embodiment of a screen protection device for a hand-held electronic device is disclosed comprising: a plastic sheet comprising a first surface and a second surface; a non-transparent layer positioned on the first surface of the plastic sheet and defining a transparent area for the screen protection device, wherein the transparent area has a shape corresponding to a display screen of the hand-held electronic device; and a sticking layer positioned on at least a portion of the non-transparent layer and surrounding the transparent area, when the sticking layer attached to a upper surface of the hand-held electronic device, an air layer is formed between the display screen and the transparent area of the screen protection device, and one or more bidirectional air tunnels are formed between the sticking layer and the upper surface of the hand-held electronic device; wherein when the transparent area of the screen protection device is pressed to approach to or to contact with the display screen, air flows from the air layer to an outside space via the one or more air tunnels, and afterward air flows from the outside space to the air layer via the one or more air tunnels when the transparent area is not pressed.

Another example embodiment of a screen protection device for a hand-held electronic device is disclosed comprising: a protection sheet comprising a first surface and a second surface; a non-transparent layer positioned on the first surface of the protection sheet and defining a transparent area for the screen protection device, wherein the transparent area has a shape corresponding to a display screen of the hand-held electronic device; a sticking layer positioned on at least a portion of the non-transparent layer and surrounding the transparent area, when the sticking layer attached to a upper surface of the hand-held electronic device, an air layer is formed between the display screen and the transparent area of the screen protection device; and one or more bidirectional air tunnels arranged within the sticking layer; wherein when the transparent area of the screen protection device is pressed to approach to or to contact with the display screen, air flows from the air layer to an outside space via the one or more air tunnels, and afterward air flows from the outside space to the air layer via the one or more air tunnels when the transparent area is not pressed.

One of the advantages of the previous example embodiment is air may flows from the outside space to the air layer via the bidirectional air tunnels, let the air layer restore to the original volume and let the transparent area of the protection sheet restore to the original flat and therefore avoiding the phenomenon of the Newton's rings when the screen protection device deforms.

Another advantage of the previous example embodiment is the screen protection device is easily and quickly attached to the screen of the hand-held electronic device and avoiding the bubbles between the screen protection device and the screen.

Other advantages of the present disclosure will be further explained by the following description and drawings.

It is to be understood that both the foregoing general description and the following detailed description are example and explanatory only and are not restrictive of the invention, as claimed.

### BRIEF DESCRIPTION OF THE DRAWINGS

FIG. 1 is a schematic front view diagram of a screen protection device in accordance with an example embodiment.

FIG. 2 is a schematic cross-sectional diagram of the screen protection device along the direction A-A′ of FIG. 1.

FIG. 3 is a schematic cross-sectional diagram of the screen protection device along the direction B-B′ of FIG. 1.

FIG. 4 is a schematic cross-sectional diagram of the screen protection device along the direction C-C′ of FIG. 1.

FIG. 5 is a schematic enlarged diagram of a partial area in FIG. 4 in accordance with an example embodiment.

FIGS. 6-11 are simplified schematic diagrams of bidirectional air tunnels in FIG. 5 in accordance with different example embodiments.

FIG. 12 and FIG. 13 are schematic enlarged diagrams of a partial area in FIG. 4 in accordance with different example embodiments.

FIG. 14 is a schematic back view diagram of the screen protection device in accordance with another example embodiment.

FIG. 15 is a schematic cross-sectional diagram of the screen protection device along the direction D-D′ of FIG. 14.

### DETAILED DESCRIPTION

Reference will now be made in detail to embodiments of the invention, which are illustrated in the accompanying drawings.

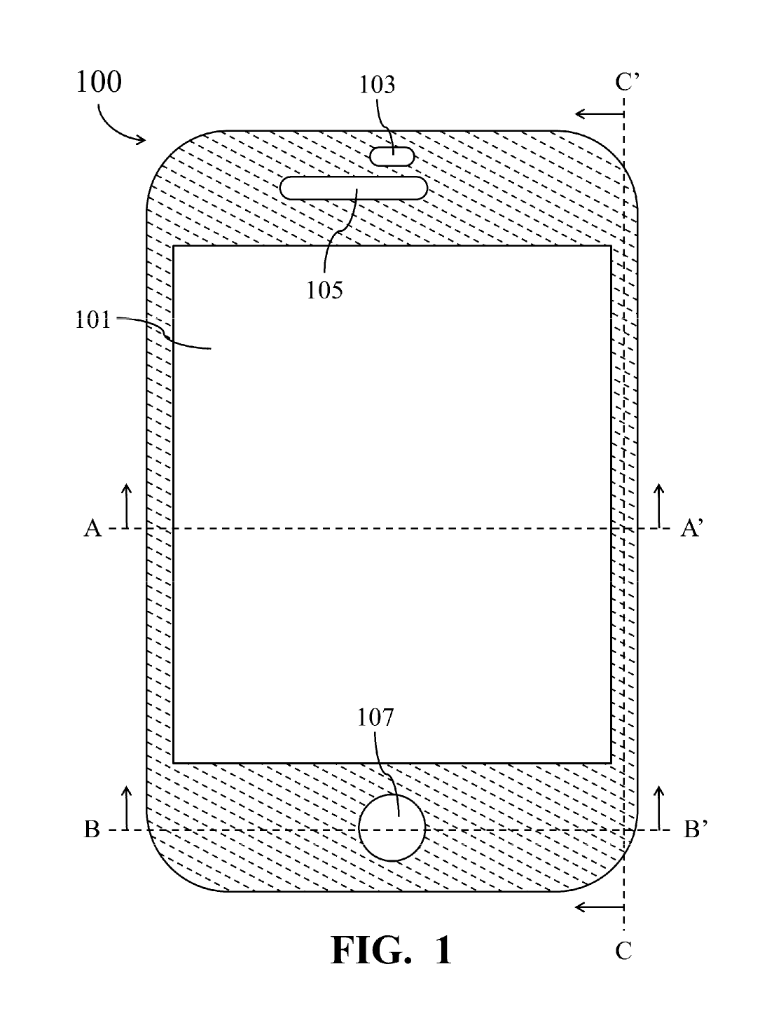

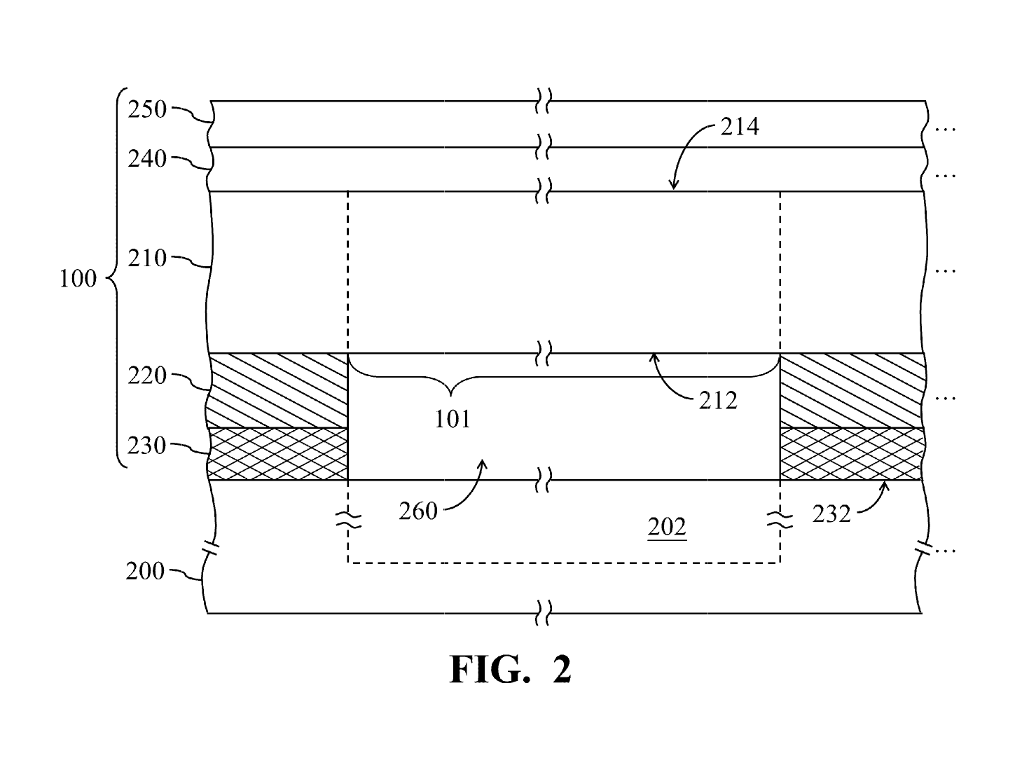

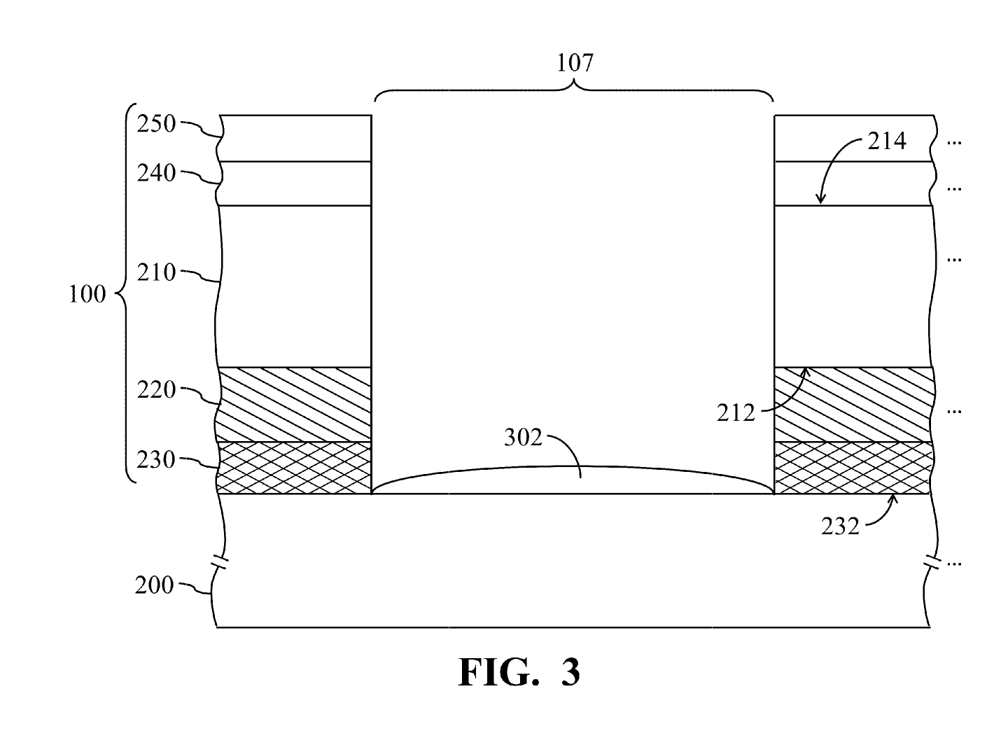

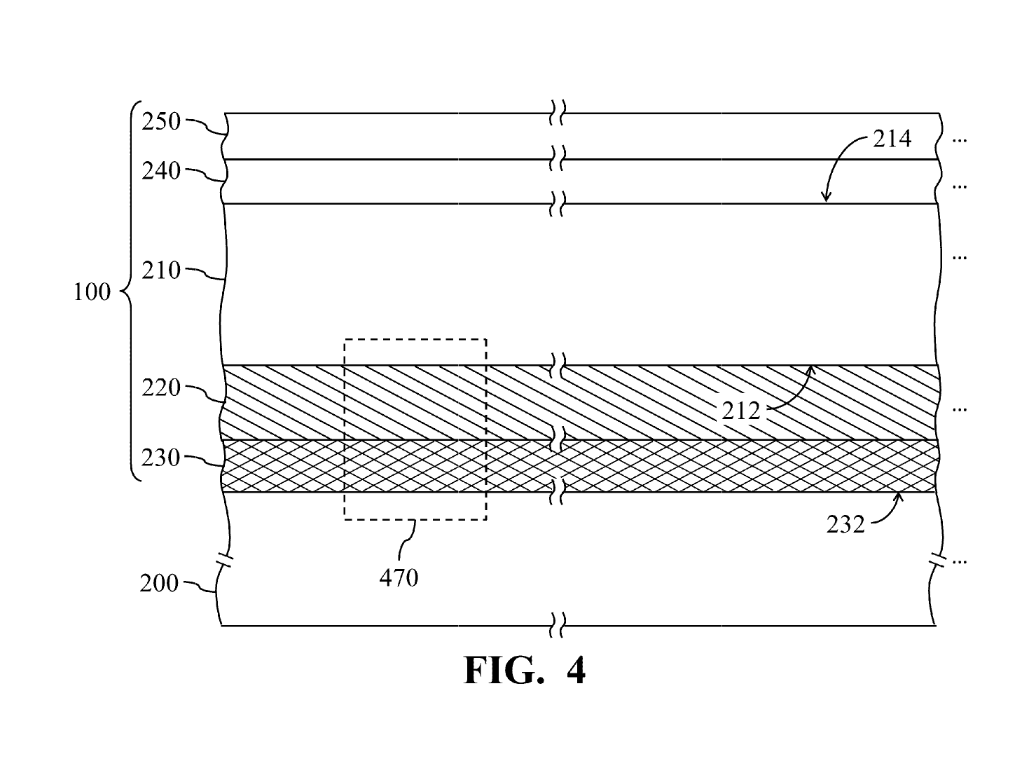

Please refer to FIG. 1 to FIG. 4. FIG. 1 is a schematic front view diagram of a screen protection device 100 in accordance with an example embodiment. FIG. 2 is a schematic cross-sectional diagram of the screen protection device 100 along the direction A-A′ of FIG. 1. FIG. 3 is a schematic cross-sectional diagram of the screen protection device 100 along the direction B-B′ of FIG. 1. FIG. 4 is a schematic cross-sectional diagram of the screen protection device 100 along the direction C-C′ of FIG. 1. The screen protection device 100 may be utilized for attaching onto a display screen 202 of a hand-held electronic device 200 to avoid the surface of the display screen 202 from being damaged. The screen device 100 may be provided with several openings corresponding to the apparatuses on the hand-held electronic device 200. In the embodiment of FIG. 1, openings 103 and 105 are positioned near one end of the screen protection device 100, and an opening 107 is positioned near the other end of the screen protection device 100. Openings 103, 105, and 107 are positioned corresponding to a front-end camera, an earphone, or a control button of the hand-held electronic device 200 to avoid the previous elements from being blocked by the screen protection device 100. When the user wants to attach the screen protection device 100 onto the hand-held electronic device 200, the openings 103, 105, and 107 may be utilized for basis of alignment so that the user can accurately attach the screen protection device 100 onto the hand-held electronic device 200.

As shown in FIG. 2 through FIG. 4, the screen protection device 100 of this embodiment comprises a tempered glass sheet 210, a non-transparent layer 220, a sticking layer 230, a harden layer 240, and an antibacterial layer 250. The tempered glass sheet 210 is utilized as a protection sheet in the screen protection device 100 and the tempered glass sheet 210 comprises a first surface 212 and a second surface 214. The non-transparent layer 220 is positioned on the first surface 212 of the tempered glass sheet 210 and defines a transparent area 101 for the screen protection device 100, wherein the transparent area 101 has a shape corresponding to a display screen 202 of the hand-held electronic device 200. The sticking layer 230 is positioned on at least a portion of the non-transparent layer 220 and surrounds the transparent area 101. The sticking layer 230 comprises a sticking surface 232 for detachably attaching onto an upper surface of the hand-held electronic device 200. The harden layer 240 is positioned on the second surface 214 of the tempered glass sheet 210 to protect the second surface 214. The antibacterial layer 250 is positioned on the harden layer 240 to reduce or avoid bacteria.

In order to provide sufficient rigidity and elastic restoring force for the screen protection device 100, the tempered glass sheet 210 may be designed to have a thickness between 0.35 to 0.7 millimeters, such as 0.5 millimeters.

The non-transparent layer 220 may be realized by an opaque or a translucent material to mask the sticking layer 230. In implementations, the non-transparent layer 220 may be formed by printing dyes of a specific color, such as black or white, on the first surface 212 of the tempered glass sheet 210.

With the sticking layer 230, the screen protection device 100 may be removed from the upper surface of the hand-held electronic device 200 easily and quickly without leaving any residue or trace of glue on the surface of the hand-held electronic device 200, so that no negative impact would be caused to the appearance or the display quality of the hand-held electronic device 200. In addition, the sticking layer 230 may be detachably attached to the upper surface of the hand-held electronic device 200 by using an electrostatic adhesion method or other adhesion methods.

In this embodiment, a hardener is coated on the second surface 214 of the tempered glass sheet 210 to form the harden layer 240 so as to increase the hardness of the screen protection device 100. Additionally, an AF potion or an AS potion may be coated on the harden layer 240. The AF potion or the AS potion forms the antibacterial layer 250 after drying. The antibacterial layer 250 provides anti-smudge and nano-antibacterial functionalities to reduce or avoid bacteria.

As shown in FIG. 2, the non-transparent layer 220 and the sticking layer 230 are only positioned in the periphery area of the screen protection device 100. Therefore, when the screen protection device 100 is attached to the upper surface of the hand-held electronic device 200, the non-transparent layer 220 and the sticking layer don't cover the display screen 202 of the hand-held electronic device 200. In addition, when the sticking surface 232 of the sticking layer 230 is attached to the upper surface of the hand-held electronic device 200, an air layer 260 is formed between the display screen 202 and the transparent area 101 of the screen protection device 100 and surrounded by the non-transparent layer 220 and the sticking layer 230. As a result, the presence of bubbles between the screen protection device 100 and the display screen 202 of the hand-held electronic device 200 can be effectively avoided.

In general, it is easier to control the thickness of the non-transparent layer 220 and thus the thickness of the air layer 260 may be primarily determined by the thickness of the non-transparent layer 220. In an embodiment, the sticking layer 230 has a thickness smaller than or equal to a thickness of the non-transparent layer 220 to reduce the amount of adhesive required for the sticking layer 230.

As shown in FIG. 3, when the screen protection device 100 is attached to the upper surface of the hand-held electronic device 200, the opening 107 of the screen protection device 100 is aligned to the control button 302 on the hand-held electronic device 200, so that the user may directly press the control button 302 via the opening 107 to operate the hand-held electronic device 200.

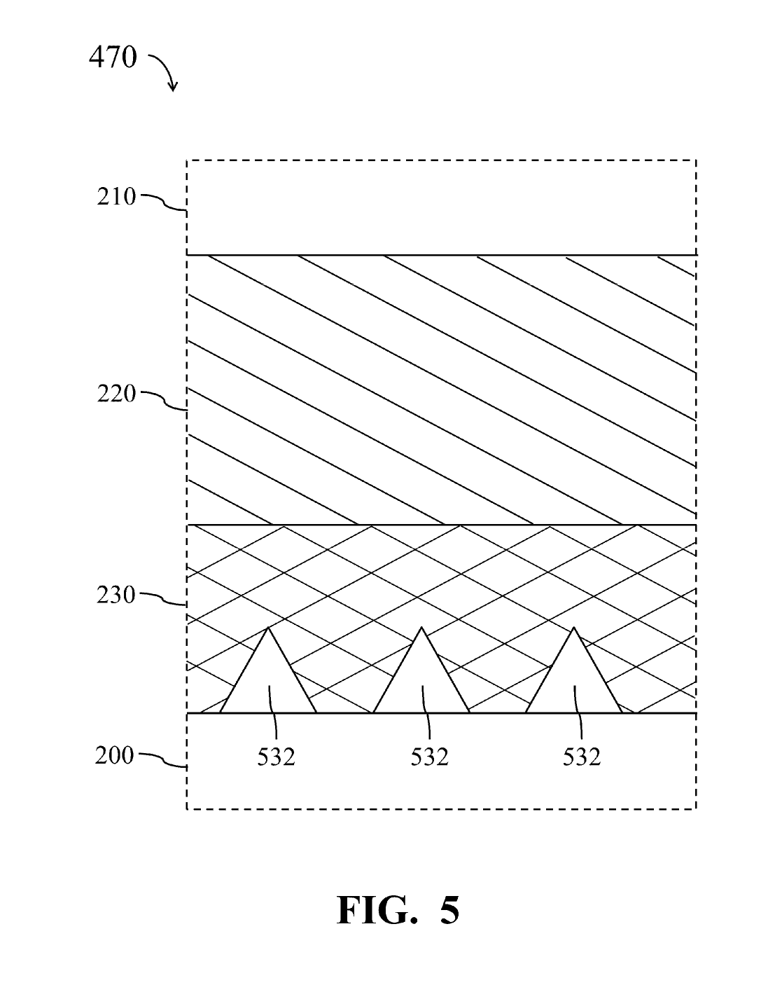

FIG. 5 is a schematic enlarged diagram of a partial area 470 of FIG. 4 in accordance with an example embodiment. As shown in FIG. 5, when the sticking layer 230 is attached to the upper surface of the hand-held electronic device 200, the one or more bidirectional air tunnels 532 are formed between the sticking layer 230 and the upper surface of the hand-held electronic device 200. Each of the bidirectional air tunnels 532 has a terminal connected to the air layer 260 and another terminal connected to an outside space, so that air can flow between the air layer 260 and the outside space through the bidirectional air tunnels 532. When the user operates the display screen 202 of the hand-held electronic device 200 through the screen protection device 100, the transparent area 101 of the screen protection device 100 approaches to or contacts with the display screen 202 due to the user's press. At this time, air flows from the air layer 260 to the outside space via the one or more bidirectional air tunnels 532 since the volume of the air layer 260 is squeezed. Afterwards, when the transparent area 101 is not pressed, the elastic restoring force of the tempered glass sheet 210 would attempt to make the screen protection device 100 to restore to a flat status. At this time, air flows from the outside space to the air layer 260 via the bidirectional air tunnels 532 to make the screen protection device 100 to restore to the flat status and balance the air pressure between the air layer 260 and the outside space. Accordingly, this prevents the screen protection device 100 from becoming unable to restore to the flat status, thereby avoiding the phenomenon of Newton's rings.

In implementations, one or more notches may be positioned on the sticking surface 232 of the sticking layer 230, so as to form the one or more bidirectional air tunnels 532 when the sticking surface 232 is attached to the upper surface of the hand-held electronic device 200.

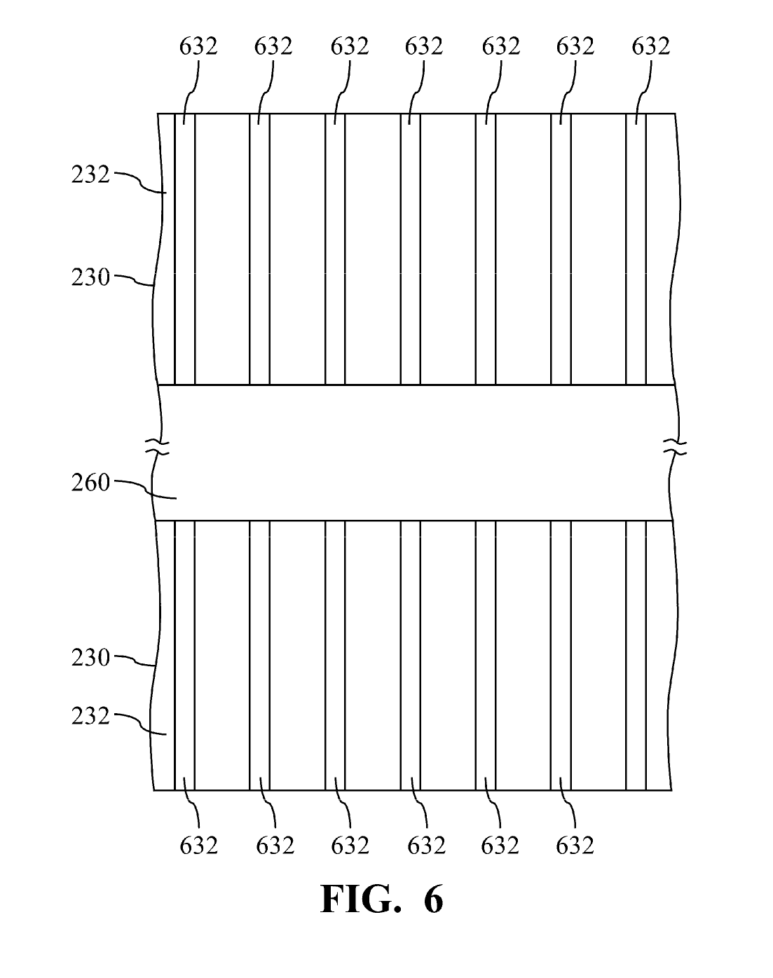

For example, FIGS. 6-10 are simplified schematic diagrams of the bidirectional air tunnels 532 in FIG. 5 in accordance with different example embodiments. In the embodiment of FIG. 6, the sticking surface 232 of the sticking layer 230 comprises a plurality of strip notches 632 arranged in a parallel pattern. When the sticking surface 232 is attached to the upper surface of the hand-held electronic device 200, the notches 632 on the sticking surface 232 cooperate with the upper surface to form a plurality of parallel bidirectional air tunnels 532, so that air can flow into or flow out from the air layer 260.

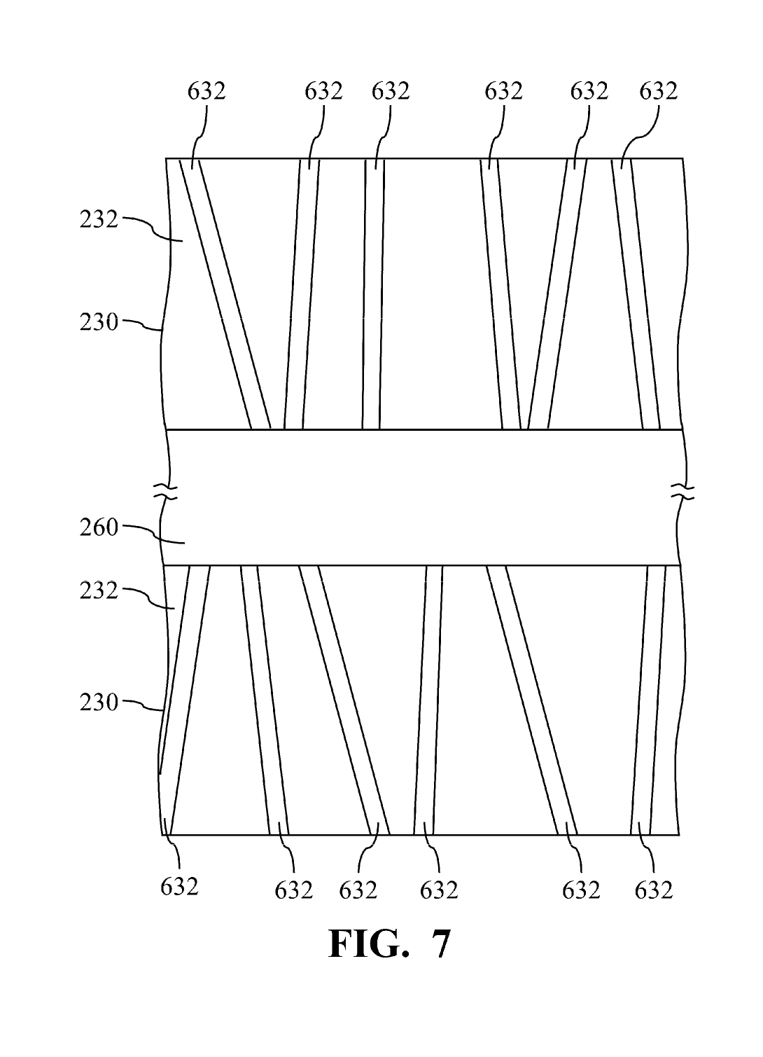

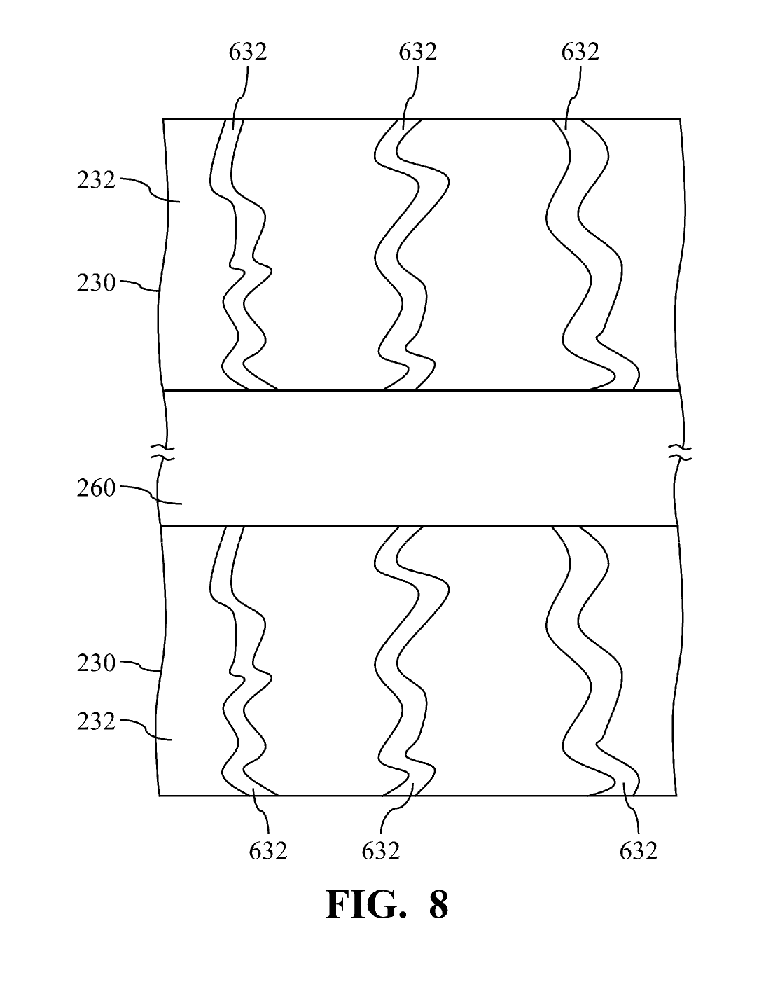

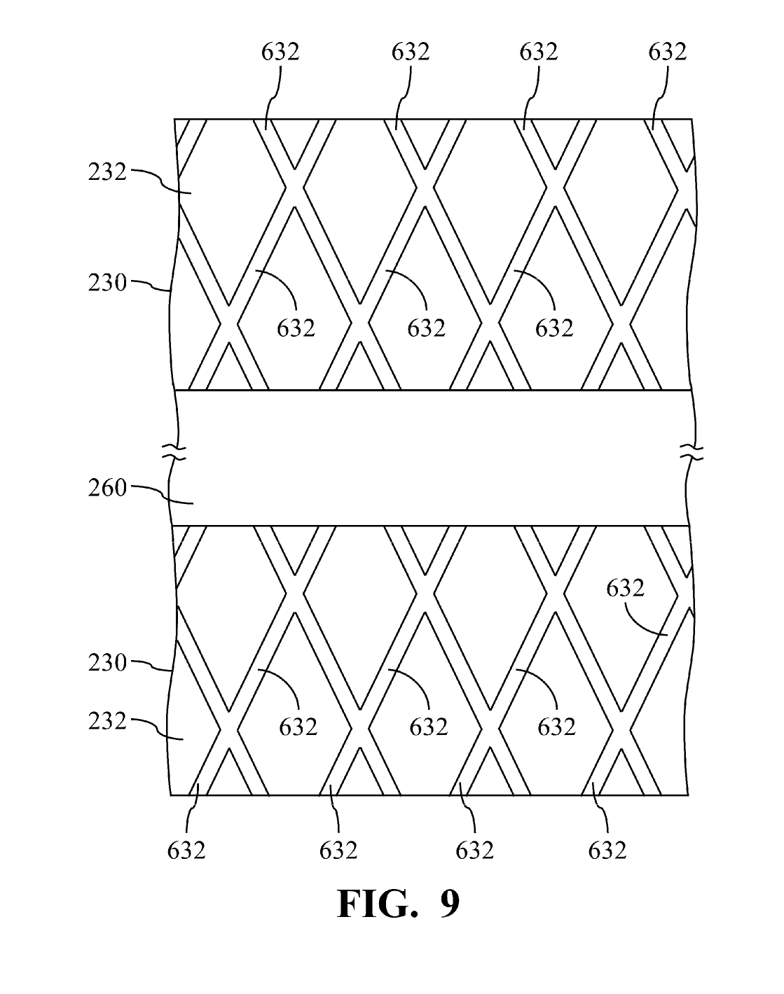

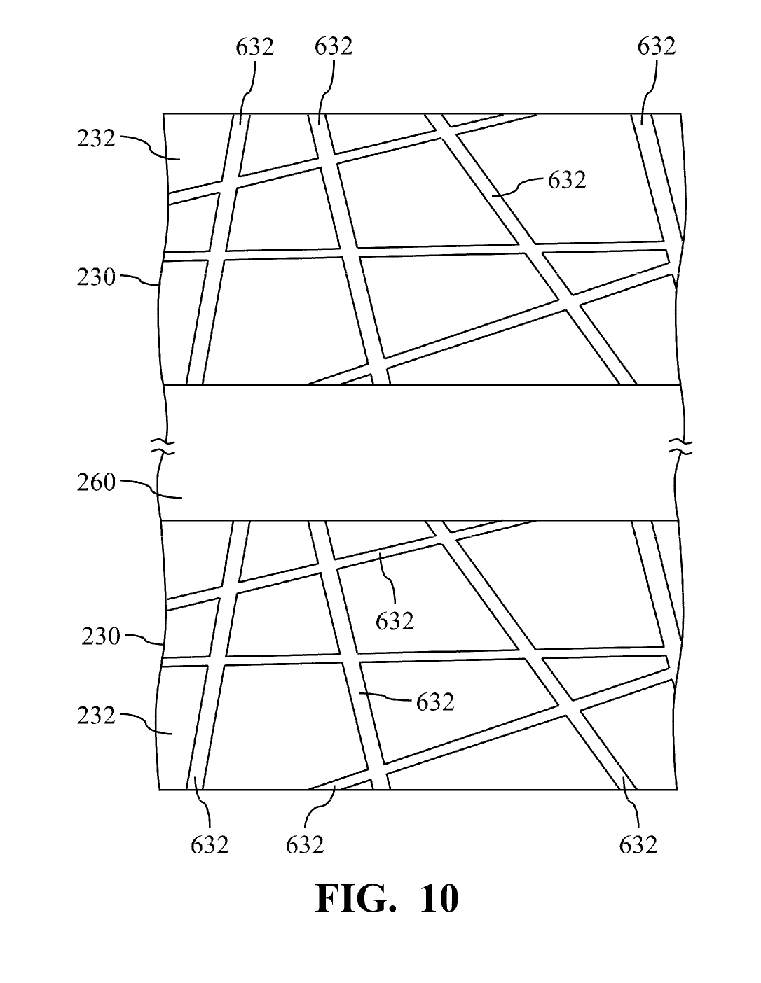

In the embodiment of FIG. 7, a plurality of strip notches 632 on the sticking surface 232 of the sticking layer 230 are arranged in an irregular pattern. In the embodiment of FIG. 8, a plurality of notches 632 on the sticking surface 232 of the sticking layer 230 are extended in an irregular pattern. In the embodiment of FIG. 9, a plurality of strip notches 632 on the sticking surface 232 of the sticking layer 230 are staggered to form a regular grid pattern. In the embodiment of FIG. 10, a plurality of strip notches 632 on the sticking surface 232 of the sticking layer 230 are staggered to form an irregular grid pattern.

In implementations, a plurality of protrusions may be positioned on the sticking surface 232 of the sticking layer 230, so that gaps of the protrusions form the afore-mentioned one or more bidirectional air tunnels 532 when the sticking surface 232 is attached to the upper surface of the hand-held electronic device 200.

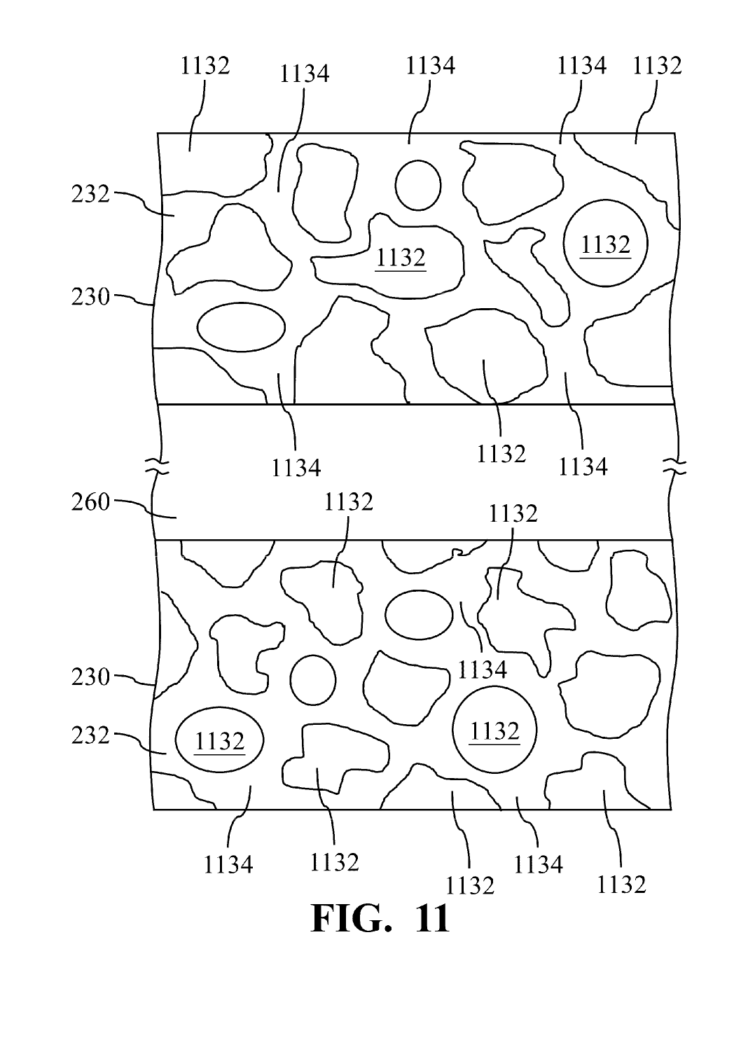

For example, in the embodiment of FIG. 11, a plurality of protrusions 1132 of different shapes and sizes are positioned on the sticking surface 232 of the sticking layer 230. When the sticking surface 232 is attached to the upper surface of the hand-held electronic device 200, gaps 1134 of the plurality of protrusions 1132 on the sticking surface 232 form the one or more irregular bidirectional air tunnels 532, so that air can flow into or flow out from the air layer 260. If the plurality of protrusions 1132 on the sticking surface 232 are designed to have different shapes and sizes, the bidirectional air tunnels 532 beneath the non-transparent layer 220 may not perceived by human eyes. Therefore, the thickness and/or required dye concentration of the non-transparent layer 220 can be reduced.

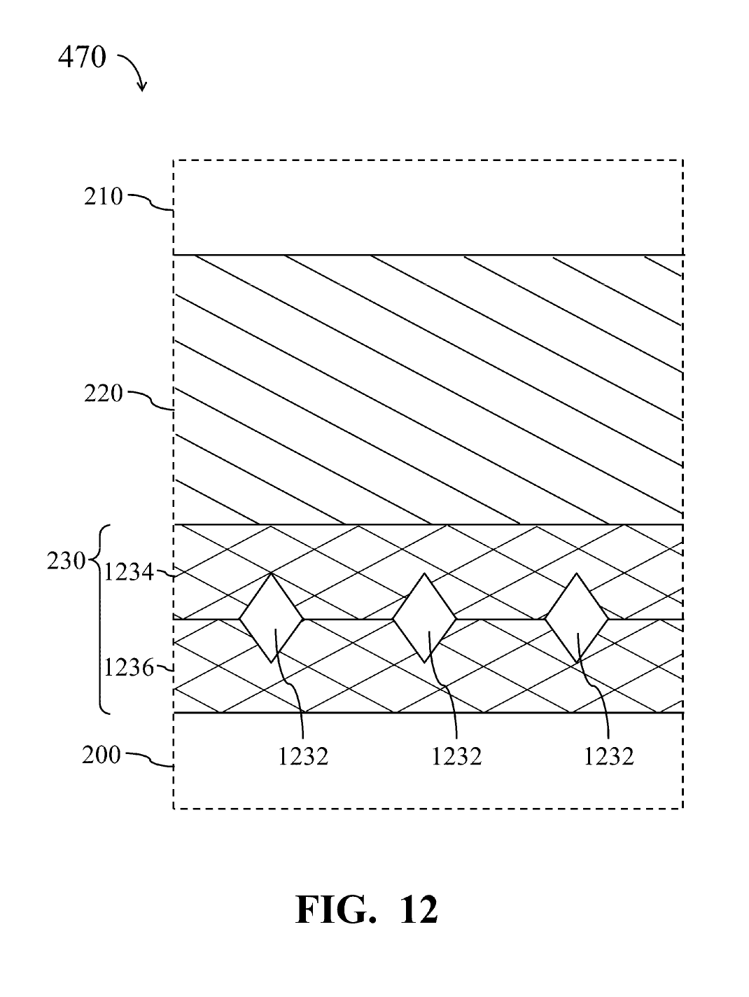

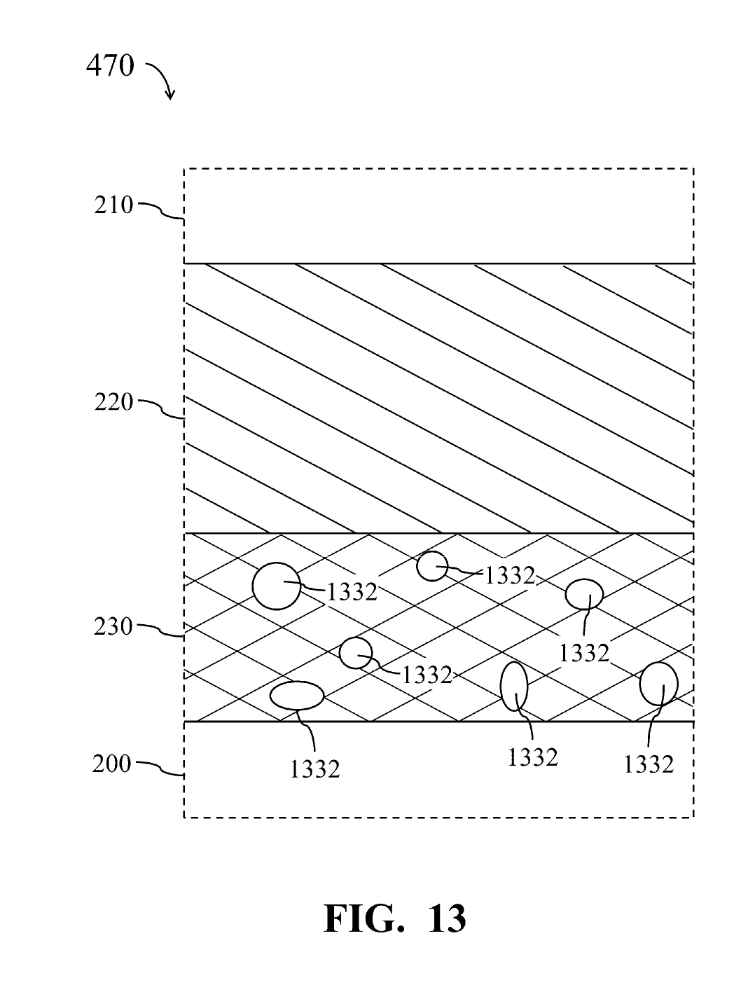

In the previous structure, the bidirectional air tunnels 532 are positioned between the sticking layer 230 and the upper surface of the hand-held electronic device 200, but this is merely an example rather than a restriction to the practical implementation. For example, FIG. 12 and FIG. 13 are schematic enlarged diagrams of a partial area 470 in FIG. 4 in accordance with different example embodiments. In the embodiment of FIG. 12, the sticking layer 230 is formed by attaching two sub sticking layers 1234 and 1236 having afore-mentioned notches structure to each other. In this structure, the notches of the sub sticking layers 1234 and 1236 cooperate to form one or more bidirectional air tunnels 1232. Accordingly, the bidirectional air tunnels 1232 are positioned within the sticking layer 230.

The same as the previous bidirectional air tunnels 532, each of the bidirectional air tunnels 1232 has a terminal connected to the air layer 260 and another terminal connected to the outside space, so that air can flow between the air layer 260 and the outside space through the bidirectional air tunnels 1232.

In the embodiment of FIG. 13, one or more bidirectional air tunnels 1332 realized by carbon nanotubes or other bidirectional conducting tubes are positioned within the sticking layer 230, and different bidirectional air tunnels 1332 may have different shapes and positions. Similarly, each of the bidirectional air tunnels 1332 has a terminal connected to the air layer 260 and another terminal connected to the outside space, so that air can flow between the air layer 260 and the outside space through the bidirectional air tunnels 1332.

As can be seen from the foregoing descriptions, the use of the bidirectional air tunnels 532, 1232, or 1332 allow air to flow between the air layer 260 and the outside space. Accordingly, when the transparent area 101 of the screen protection device 100 is pressed to approach to or to contact with the display screen 202, air flows from the air layer 260 to the outside space via the afore-mentioned one or more bidirectional air tunnels 1232 or 1332. Afterwards, when the transparent area 101 is not pressed, air flows from the outside space to the air layer 260 via the bidirectional air tunnels 1232 or 1332, so that the screen protection device 100 can easily restore to the flat status, thereby avoiding the screen protection device 100 from the phenomenon of Newton's rings.

In an embodiment, each of the previous bidirectional air tunnels 532, 1232, or 1332 may be designed to have an aperture between 0.05 to 0.09 millimeters, such as 0.07 millimeters, to avoid dust entering into the air layer 260 via the bidirectional air tunnels, so that the viewing quality is not be adversely affected by dust.

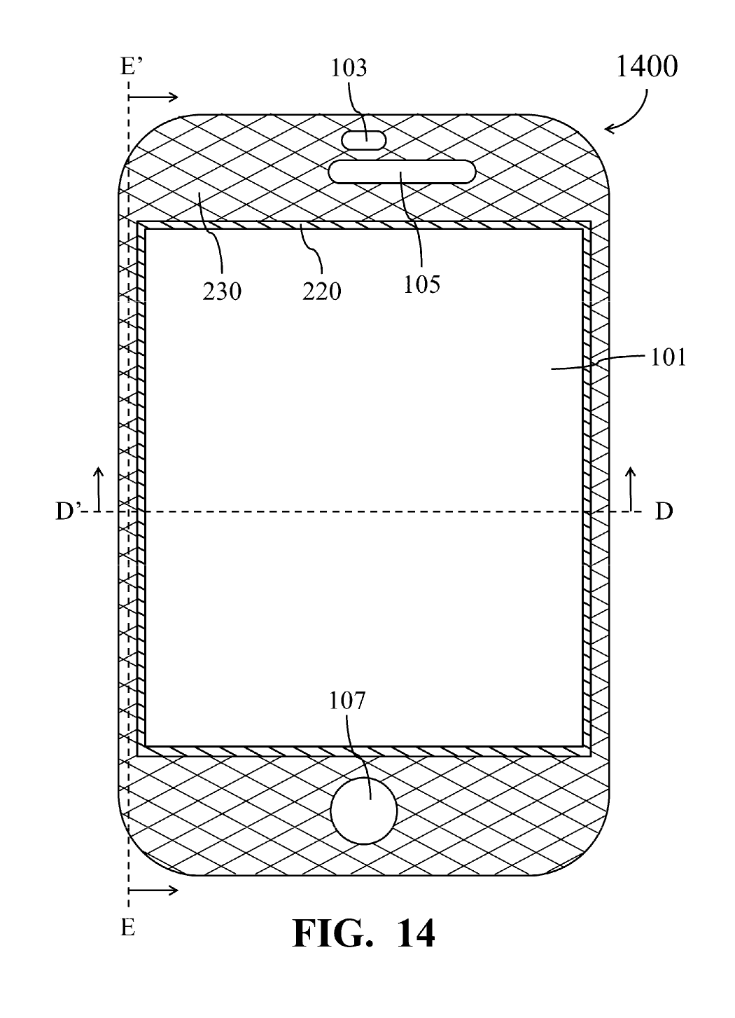

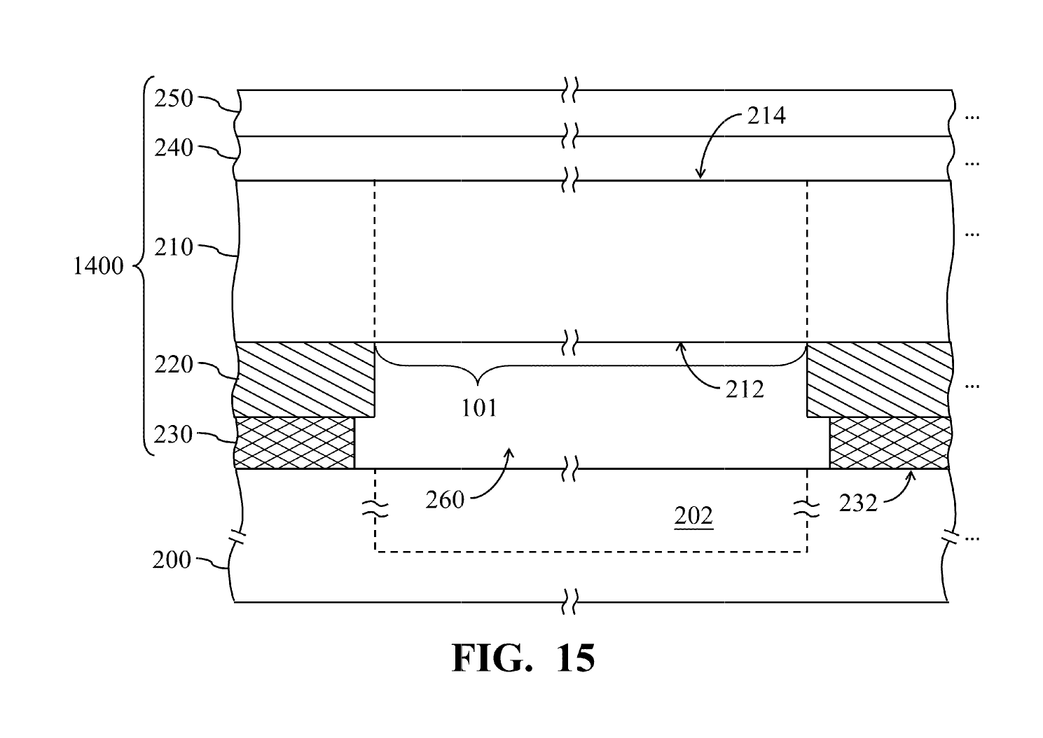

Please refer to FIG. 14 and FIG. 15. FIG. 14 is a schematic back view diagram of the screen protection device 1400 in accordance with another example embodiment. FIG. 15 is a schematic cross-sectional diagram of the screen protection device 1400 along the direction D-D′. The screen protection device 1400 is similar to the previous screen protection device 100, and the difference between the two embodiments is the area of the sticking layer 230 of the screen protection device 1400 is smaller to the area of the non-transparent layer 220. Therefore, as shown in FIG. 14, it can be seen from the back view of the screen protection device 1400 that some regions of the non-transparent layer 220 are not completely masked by the sticking layer 230. Such arrangement effectively avoids the sticking layer 230 from exposing to the scope of the transparent area 101 due to the misalignment in the manufacturing process. From another perspective, such arrangement provides a higher position error tolerance when coating the sticking layer 230 onto the non-transparent layer 220, thereby increasing the manufacturing speed and yield rate of the screen protection device 1400.

In this embodiment, the schematic cross-sectional diagram of the screen protection device 1400 along the direction E-E′ is the same as the previous schematic cross-sectional diagram of the screen protection device 100 along the direction C-C′. Accordingly, the descriptions regarding the implementations and advantages of the previous embodiments of the bidirectional air tunnels 532, 1232, or 1332 in FIG. 4 through FIG. 13 are also applicable to this embodiment. For simplicity, the descriptions will not be repeated here.

In implementations, a plastic sheet may be utilized for replacing the tempered glass sheet 210 in the previous screen protection device 100 or 1400 and utilized as the protection sheet of the screen protection device 100 or 1400. Since the previous bidirectional air tunnels 532, 1232, or 1332 allow air to flow between the air layer 260 and the outside space, even the elastic restoring force of the selected plastic sheet is smaller than the previous tempered glass sheet 210, the screen protection device utilizing the plastic sheet as the protection sheet can still restore to the flat status with the use of the bidirectional air tunnels 532, 1232, or 1332, thereby avoiding the screen protection device from the phenomenon of the Newton's rings.

Additionally, in some embodiments, the previous harden layer 240 and/or the antibacterial layer 250 may be omitted to further simplify the structure of the screen protection device.

Throughout the description and claims, the term “element” contains the concept of component, layer, or region.

In the drawings, the size and relative sizes of some elements may be exaggerated or simplified for clarity. Accordingly, unless the context clearly specifies, the shape, size, relative size, and relative position of each element in the drawings are illustrated merely for clarity, and not intended to be used to restrict the claim scope.

For the purpose of explanatory convenience in the specification, spatially relative terms, such as “on,” “above,” “below,” “beneath,” “higher,” “lower,” “upward,” “downward,” and the like, may be used herein to describe the function of a particular element or to describe the relationship of one element to another element(s) as illustrated in the drawings. It will be understood that the spatially relative terms are intended to encompass different orientations of the element in use, in operations, or in assembly in addition to the orientation depicted in the drawings. For example, if the element in the drawings is turned over, elements described as “on” or “above” other elements would then be oriented “under” or “beneath” the other elements. Thus, the exemplary term “beneath” can encompass both an orientation of above and beneath.

Throughout the description and claims, it will be understood that when a component is referred to as being “positioned on,” “positioned above,” “connected to,” “engaged with,” or “coupled with” another component, it can be directly on, connected, or engaged with the other component or intervening component may be present. In contrast, when a component is referred to as being “directly on,” “directly connected to,” or “directly engaged with” another component, there are no intervening components present.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A screen protection device for a hand-held electronic device, comprising:
a tempered glass sheet comprising a first surface and a second surface;
a non-transparent layer positioned on the first surface of the tempered glass sheet and defining a transparent area for the screen protection device, wherein the transparent area has a shape corresponding to a display screen of the hand-held electronic device; and
a sticking layer positioned on at least a portion of the non-transparent layer and surrounding the transparent area, when the sticking layer attached to a upper surface of the hand-held electronic device, an air layer is formed between the display screen and the transparent area of the screen protection device, and one or more bidirectional air tunnels are formed between the sticking layer and the upper surface of the hand-held electronic device;
wherein when the transparent area of the screen protection device is pressed to approach to or to contact with the display screen, air flows from the air layer to an outside space via the one or more air tunnels, and afterward air flows from the outside space to the air layer via the one or more air tunnels when the transparent area is not pressed.

2. The screen protection device of claim 1, wherein the sticking layer has an area smaller than an area of the non-transparent layer.

3. The screen protection device of claim 1, wherein the sticking layer has a thickness smaller than or equal to a thickness of the non-transparent layer.

4. The screen protection device of claim 1, wherein the sticking layer comprises a sticking surface for attaching onto the upper surface of the hand-held electronic device, and the sticking surface comprises one or more notches formed thereon;
wherein when the sticking surface is attached to the upper surface, the one or more bidirectional air tunnels are formed by the one or more notches.

5. The screen protection device of claim 4, wherein the one or more notches comprises a plurality of notches arranged in a parallel pattern or an irregular pattern, or forming a grid pattern.

6. The screen protection device of claim 1, wherein the sticking layer comprises a sticking surface for attaching onto the upper surface of the hand-held electronic device, and the sticking surface comprises a plurality of protrusions of different shapes and sizes;
wherein when the sticking surface is attached to the upper surface, the one or more bidirectional air tunnels are formed by gaps of the plurality of protrusions.

7. The screen protection device of claim 1, further comprising:
a harden layer positioned on the second surface of the tempered glass sheet to protect the second surface of the tempered glass sheet;
wherein the tempered glass sheet has a thickness between 0.35 to 0.7 millimeters and each of the bidirectional air tunnels has an aperture between 0.05 to 0.09 millimeters.

8. The screen protection device of claim 7, further comprising:
an antibacterial layer positioned on the harden layer to reduce or avoid bacteria.

9. A screen protection device for a hand-held electronic device, comprising:
a plastic sheet comprising a first surface and a second surface;
a non-transparent layer positioned on the first surface of the plastic sheet and defining a transparent area for the screen protection device, wherein the transparent area has a shape corresponding to a display screen of the hand-held electronic device; and
a sticking layer positioned on at least a portion of the non-transparent layer and surrounding the transparent area, when the sticking layer attached to a upper surface of the hand-held electronic device, an air layer is formed between the display screen and the transparent area of the screen protection device, and one or more bidirectional air tunnels are formed between the sticking layer and the upper surface of the hand-held electronic device;
wherein when the transparent area of the screen protection device is pressed to approach to or to contact with the display screen, air flows from the air layer to an outside space via the one or more air tunnels, and afterward air flows from the outside space to the air layer via the one or more air tunnels when the transparent area is not pressed.

10. The screen protection device of claim 9, wherein the sticking layer has an area smaller than an area of the non-transparent layer.

11. The screen protection device of claim 9, wherein the sticking layer has a thickness smaller than or equal to a thickness of the non-transparent layer.

12. The screen protection device of claim 9, wherein the sticking layer comprises a sticking surface for attaching onto the upper surface of the hand-held electronic device, and the sticking surface comprises one or more notches formed thereon;
wherein when the sticking surface is attached to the upper surface, the one or more bidirectional air tunnels are formed by the one or more notches.

13. The screen protection device of claim 12, wherein the one or more notches comprises a plurality of notches arranged in a parallel pattern or an irregular pattern, or forming a grid pattern.

14. The screen protection device of claim 9, wherein the sticking layer comprises a sticking surface for attaching onto the upper surface of the hand-held electronic device, and the sticking surface comprises a plurality of protrusions of different shapes and sizes;
wherein when the sticking surface is attached to the upper surface, the one or more bidirectional air tunnels are formed by gaps of the plurality of protrusions.

15. The screen protection device of claim 9, further comprising:
a harden layer positioned on the second surface of the plastic sheet to protect the second surface of the plastic sheet;
wherein each of the bidirectional air tunnels has an aperture between 0.05 to 0.09 millimeters.

16. The screen protection device of claim 15, further comprising:
an antibacterial layer positioned on the harden layer to reduce or avoid bacteria.

17. A screen protection device for a hand-held electronic device, comprising:
a protection sheet comprising a first surface and a second surface;
a non-transparent layer positioned on the first surface of the protection sheet and defining a transparent area for the screen protection device, wherein the transparent area has a shape corresponding to a display screen of the hand-held electronic device;
a sticking layer positioned on at least a portion of the non-transparent layer and surrounding the transparent area, when the sticking layer attached to a upper surface of the hand-held electronic device, an air layer is formed between the display screen and the transparent area of the screen protection device; and
one or more bidirectional air tunnels arranged within the sticking layer;
wherein when the transparent area of the screen protection device is pressed to approach to or to contact with the display screen, air flows from the air layer to an outside space via the one or more air tunnels, and afterward air flows from the outside space to the air layer via the one or more air tunnels when the transparent area is not pressed.

18. The screen protection device of claim 17, wherein the sticking layer has an area smaller than an area of the non-transparent layer.

19. The screen protection device of claim 17, wherein the sticking layer has a thickness smaller than or equal to a thickness of the non-transparent layer.

20. The screen protection device of claim 17, wherein the one or more bidirectional air tunnels comprises a plurality of bidirectional air tunnels arranged in a parallel pattern or an irregular pattern, or forming a grid pattern.

21. The screen protection device of claim 17, wherein the protection sheet is a plastic sheet or a tempered glass sheet.

22. The screen protection device of claim 17, further comprising:
a harden layer positioned on the second surface of the protection sheet to protect the second surface of the protection sheet;
wherein the protection sheet has a thickness between 0.35 to 0.7 millimeters and each of the bidirectional air tunnels has an aperture between 0.05 to 0.09 millimeters.

23. The screen protection device of claim 22, further comprising:
an antibacterial layer positioned on the harden layer to reduce or avoid bacteria.
